(19) United States
(12) Patent Application Publication
(10) Pub. No.: US 2004/0021867 A1
(43) Pub. Date: Feb. 5, 2004

(54) Device for carrying out biochemical fluorescence tests

(76) Inventors: Wolfgang Karthe, Jena (DE); Ralf Waldhausl, Jena (DE); Andreas Brauer, Schloben (DE); Norbert Danz, Jena (DE); Ralf Kinderwater, Jena (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/333,371

(22) PCT Filed: Jul. 19, 2001
(86) PCT No.: PCT/DE01/02776

(30) Foreign Application Priority Data
Jul. 19, 2000 (DE) 100-35-101.8
Mar. 9, 2001 (DE) 101-12-455.4

(51) Int. Cl. G01N 21/25

(52) U.S. Cl. 356/417

(57) ABSTRACT

The invention relates to a device for carrying out biochemical fluorescence tests by means of which the different biochemical interactions can be detected. With the aid of the invention it shall be allowed for a very large number of individual samples to be detected low costly and with a high sensitivity, and in addition it shall be achieved a high spatial resolution. According to the invention this object is solved with a device by means of which linearly polarized light of a laser diode is directed upon a plate-shaped carrier through an optical arrangement comprising at least one polarization beam splitter, a quarter-wave plate and a focussing optical element. In addition to binary, optically detectable information structures a plurality of fluorophore-marked samples is discretely arranged as well on the carrier rotating about an axis. Light reflected on the information structures is directed upon an optical detector by means of the optical arrangement for detecting information, and fluorescent light emitted from the fluorophore-marked samples is directed upon an optical detector for the fluorescent light via a spectral filter separating in a wavelength-selective and spatial manner.

The invention relates to a device for carrying out biochemical fluorescence tests by means of which the different biochemical interactions can be detected. On that occasion, different so-called assay formats per se well-known such as fluorescence immunologic tests and investigations as well can be carried out for decoding the genome of plants or animals. More especially advantageously, the invention can be performed for the investigation of a very large number of samples in a short time as this is desired with the so-called “screening applications”.

In the well-known prior art, for this it is proposed to use rotating carrier media for a relatively large number of samples, and evaluating and performing the investigations is to be brought about with the aid of a well-known technology, and herein particularly by means of CD and DVD technologies, respectively.

Such solution proposals are mentioned in the WO 98/12559 A1, WO 99/35499 A1 and WO 00/26677 A1.

On that occasion, the contents of WO 00/26677 A1 substantially relates to the modification of per se well known CDs or DVDs and the methods of manufacturing thereof. Therein, basically it is namely indicated the possibility of carrying out tests with fluorescence excitation and the measurement of the excited fluorescent light. Explicitely, any solution starts are merely described in which colloidal particles such as gold are used to a partner of such a bond system to prove that bonding at least such two partners has been occurred as these are well-known receptor ligand systems. As a result, the reflection and absorption behaviour changed due to the colloidal particles which occurs at such bonded molecules can be used, and respective results can also be gained in a quantitative form as the case may be by means of a respective optical detection.

If in contrast the frequently used fluorescence analysis technique is used, then detection of the fluorescent light has to be measured in a wavelength selective manner with a high sensitivity, and in particular with a very high spatial resolution which it is optically not readily possible with the per se well-known CD and DVD technologies, respectively.

On that occasion, the advantages of such systems can be used therewith, however, namely the high velocity of signal detection and in particular the possibility of an almost self-regulating self-positioning of the exciting and holding elements by means of information stored on such CDs and DVDs, respectively in a form which is commonly described with “tracking”.

Hence, it is an object of the invention to propose a device for carrying out biochemical fluorescence tests by means of which an very large number of individual samples is detectable in a low cost manner and with a high sensitivity in particular with a high spatial resolution capability.

In accordance with the invention this object is achieved with a device according to claim 1. Advantageous modifications and improvements of the invention can be achieved with the features mentioned in the subordinate claims.

On that occasion, the invention takes up solution starts known from the prior art which applies in particular to insights and technical elements as well as they are used at least for reading out information of CDs and DVDs. Then, optical elements for recording various information, and in addition for the detection of fluorescence signals emitted by fluorophore-marked samples, are moved by means of a lateral movement along a radially outwardly directed axis with respect to the rotation axis of such a plate-shaped carrier rotating about a rotation axis in order to recover the desired information and test results of fluorescence with the desired positional accuracy.

With the plate-shaped carriers to be used according to the invention annular forms and, however, other geometrical designs can be used as well. Feeding and receiving, respectively of individual fluorophore-marked samples to be discretely arranged should be possible with the carriers. The fluorophore-marked samples can be applied by suitable means on one surface but also on two surfaces of a plate-shaped carrier. Thus, the surface of such a carrier is allowed to be in a microstructure wherein it is allowed to fall back upon a structuring method in addition to other well-known structuring methods such as one which is described in the not prior published document DE 100 12 793 and which disclosure thereof shall be referred to herein anticipating to the full.

However, it is also possible to form an equivalent plate-shaped carrier such that the individual fluorophore-marked samples are arranged inside the carrier. For this, cavities or channels to be charged from the outside can be formed wherein it is to be returned to actual aspects with the description of embodiments.

For the device according to the invention it is allowed to use a per se well-known CD and DVD apparatus, respectively, which is substantially optically modified. This provides a laser diode by means of which linearly polarized light in parallel with the rotation axis of the rotating plate-shaped carrier is directed upon the surface thereof. The light of the laser diode is directed upon the surface of the carrier via an optical arrangement which comprises at least one polarization beam splitter, a quarter-wave plate and a focussing optical element. Preferably, a laser diode is used, with the light of which it is allowed to excite fluorescence of at least a respectively selected fluorophore inside of fluorophore-marked samples.

In the carrier, which should advantageously be at least partially optically translucent there are binary optically detectable information structures by means of which at least the respective locus coordinates can be detected in a two dimensional manner and used for controlling the movement and for the spatially resolved measurement of the fluorescence signals. With the aid of light reflected in a different form from these information structures the respective information is allowed to be detected with an optical detector wherein according to the formation of the information structure, the optical absorption of such an information structure or a correspondingly caused phase shifting of the reflected light as well can be used to detect the individual information.

In addition to the detection of fluorescence signals of the individual fluorophore-marked samples at least one second optical detector is used for the fluorescent light wherein a wavelength-selectively and spatially separating spectral filter can be arranged inside the beam path of the fluorescent light. Advantageously, such a spectral filter can be a dichroic beam splitter.

For the extraction of at least the position information from the information structure the linearly polarized light emitting from the laser diode will be converted into circularly polarized light by means of the quarter-wave plate, and the circularly polarized light will be directed upon the surface of the carrier. The light reflected from the information structure passes upon the quarter-wave plate again likewise as circularly polarized light, and will be converted again into linearly polarized light, wherein the polarization plane of the reflected light is rotated by 90 degrees in comparison with the polarization plane of the light emitting from the laser diode. As a result, the reflected light can be deviated with the polarization beam splitter and directed upon the optical detector such that a distinct separation of information signals gained with the reflected light from light emitting from the laser diode is achievable.

For reducing the undesired influence of extraneous light it is advantageous to provide a supplemental optical filter between the spectral filter and the optical detector for the fluorescent light. For this, a bandpass filter or cut-off filter tuned to the respective wavelength of the fluorescent light can be used.

In particular with the use of a carrier which is completely or partially optically translucent at least in the areas in which fluorophore-marked samples are provided, it is possible to arrange the optical detector for the fluorescent light and the wavelength-selectively and spatially separating spectral filter respectively required on the side of the carrier which is opposite the side on which the laser diode and the optical arrangement are provided.

In this case the optical elements arranged on both sides of the carrier should be allowed to be synchronously moved, however, which can be achieved by means of a rigid mechanical coupling, for example.

However, in particular cases it may also be favourable to arrange all the optical elements on one side of the carrier such that these can be reciprocated together along the radially outwardly directed axis. Then, the spectral filter by means of which the fluorescent light is directed in a wavelength-selective manner upon the optical detector for the fluorescent light can be integrated into the optical arrangement such that the reflected light emitting from the information structures of the carrier also impinges upon this spectral filter, however, remaining not influenced by this.

In addition to the laser diode it is also possible to use at least one second possibly monochromatic light source which is likewise allowed to be a respective laser diode but an LED as well. This light source exclusively radiates light for the fluorescence excitation of one or a plurality of fluorophores which are respectively selected. The light of this second light source can be directed upon the carrier, and accordingly upon the fluorophore-marked samples as well via a wavelength-selectively and spatially separating spectral filter (dichroic beam splitter). On that occasion, the optical elements of the optical arrangement which serve to gain the information signals from the information structure can be used therewith by a respective superposition of the light of the laser diode and the second light source.

With such an arrangement it is possible to carry out fluorescence tests with at least two different fluorophores by means of which it is allowed to excite fluorescence with different wavelengths when the first laser diode is also radiating light having a suitable wavelength. Since the information structures as well as the fluorophore-marked samples can be arranged in different planes inside and on the carrier, respectively, it is advantageous to correspondingly vary the focal length of the focussing optical element which is then allowed to be adapted in the form of a lens having a variable focal length, such that the focus is located in the plane each desired, and the desired information and in particular the fluorescence signals can be detected with a very high spatial resolution.

More especially advantageously with the device according to the invention, the detection of both the optical information from the information structures and the detection of the fluorescence signals can take place in a confocal manner.

To ensure the desired high sensitivity, in particular for the fluorescent light, photo multiplier tubes (PMT), avalanche photo diodes or particularly sensitive photo diodes having preamplifiers should be used as suitable optical detectors.

Advantageously, additional collimators and condensers can be arranged inside the beam path of the different types of light in order to achieve widening and parallel aligning or focussing according to need such as it is particularly desired for the light to be directed upon the optical detectors.

Another possibility is in that to not immediately direct the fluorescent light upon an optical detector for the fluorescent light via the spectral filters and filters, but to couple fluorescent light with respectively suitable focussing lenses into an optical fibre, and to direct upon the optical detector for the fluorescent light via the optical fibre. As a result, the effort for optics and electronics can be reduced by spatial separation, and the detection of the fluorescence signals can take place in spatially separated manner such as on a fixedly mounted board.

As a result, it is possible to direct fluorescent light of different wavelengths through the optical fibres upon a respective spectral filter (e.g. dichroic beam splitter), and to direct fluorescent light therefrom each having a different wavelength upon one own optical detector each such that the use of at least two different fluorophores is possible for marking. By interposing at least one Y-splitter, which is present at the optical fibre, or an array of at least two dichroic beam splitters the number of the usable fluorophores, which emit fluorescent light at respectively different wavelengths, can be increased in a relatively simple manner.

Advantageously, a dispensing means for the samples can be connected to the electrical evaluation and control unit required anyway by a relatively simple adaptation such as it is already present on a commercially available CD and DVD apparatus, respectively, for example, such that the individual samples can be discretely and very accurately deposited upon a carrier in a spatially resolved manner or inserted into the cavities and channels respectively formed inside the carrier wherein the simple extraction of the respective locus coordinates by means of the information gainable from the information structures has a favourable effect.

With such a dispensing means it is allowed to fall back upon the per se well-known piezoelectric “ink-jet” principle by means of which a very high positioning and metering accuracy can be achieved.

If a carrier which e.g. comprises the form of a recordable CD and DVD connection, respectively, is used then with an equivalent basic instrument it is allowed to store the respective information associated to the individual samples by adequate influencing and to use them during carrying out the tests.

With the solution according to the invention it is allowed in addition to the binary information, which are readable by means of the information structures, to detect biochemical interactions as well by the fluorescence excitation in parallel and also in a serial manner, and to use them for the evaluation of the individual tests on single fluorophoro-marked samples.

On that occasion, both an very large number of individual samples can be used with one carrier, and it is simultaneously allowed to be worked with a very small sample volume for each individual sample which can also be localized very accurately during carrying out the tests. Due to the possible high apertures by means of which the excited fluorescence of individual bonded bio-molecules can also be detected, very sensitive detections are possible which allow to make quantitative statements as well.

Furthermore, in addition to the fluorescence analysis, other optical sizes varying due to occurring biochemical interactions such as modifications of the reflection and absorption are also additionally detectable in principle such that the test spectrum can be extended.

Such varying sizes can be detected as the case may be without any additional modifications with respect to the device according to the invention having the optical detector which includes the information involved in the information structure of the carrier anyway.

In the following, the invention shall be described in more detail according to embodiments then in which

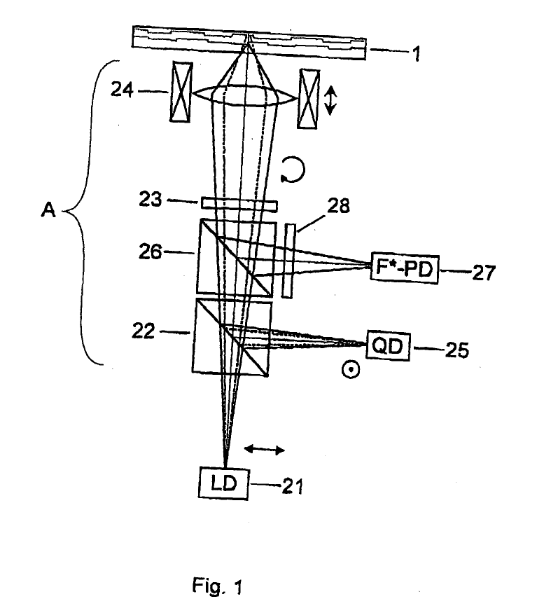

FIG. 1 shows a diagrammatic assembly of an embodiment of a device according to the invention;

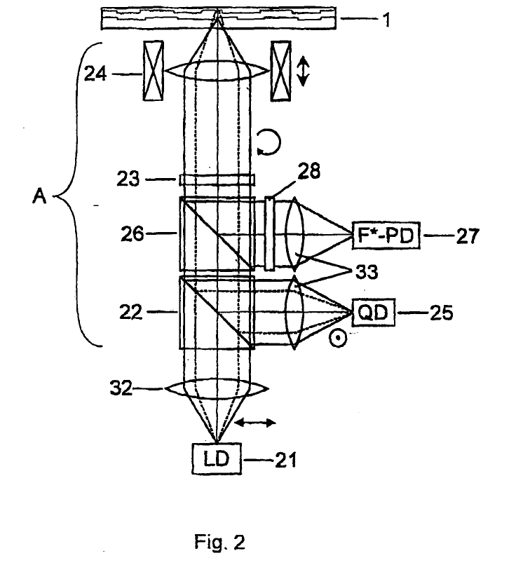

FIG. 2 shows a second embodiment with supplemental collimators and condensers;

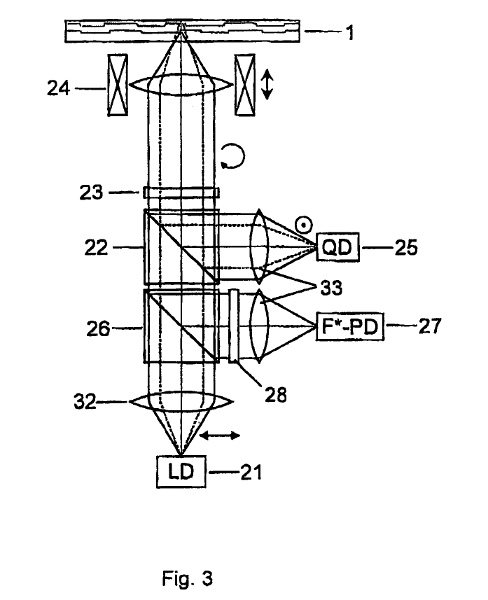

FIG. 3 shows a third embodiment with an arrangement of optical elements modified with respect to the embodiment according to FIG. 2;

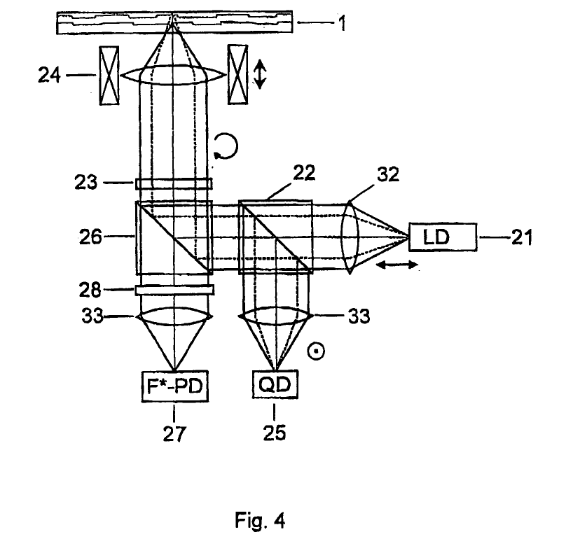

FIG. 4 shows another embodiment with an arrangement of optical elements modified with respect to the embodiment according to the FIGS. 2 and 3;

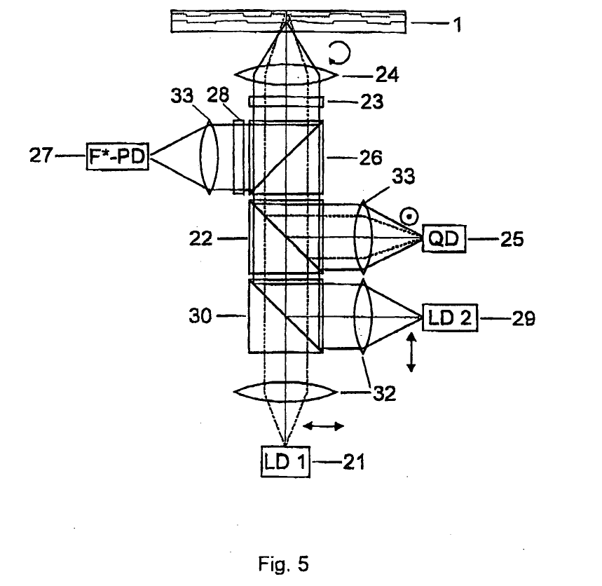

FIG. 5 shows an embodiment having an additional light source for the fluorescence excitation;

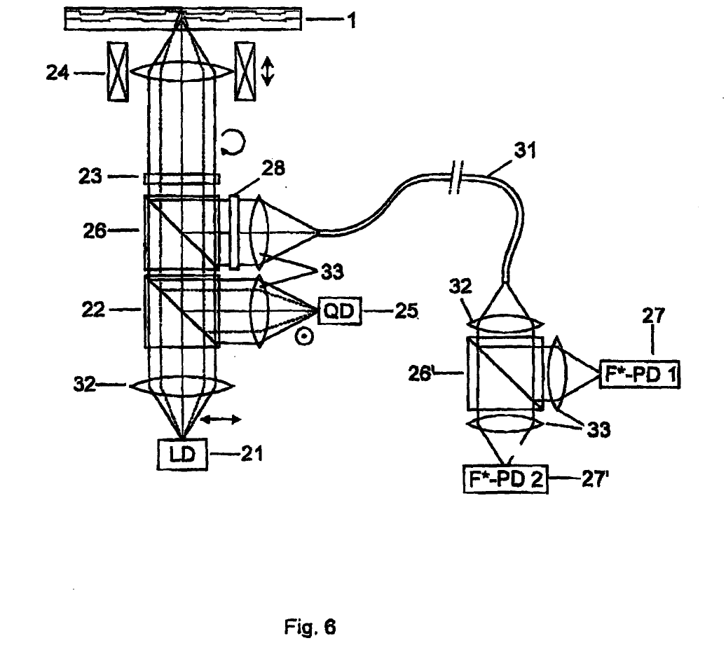

FIG. 6 shows an embodiment of a device according to the invention having an optical fibre for the guidance of fluorescent light;

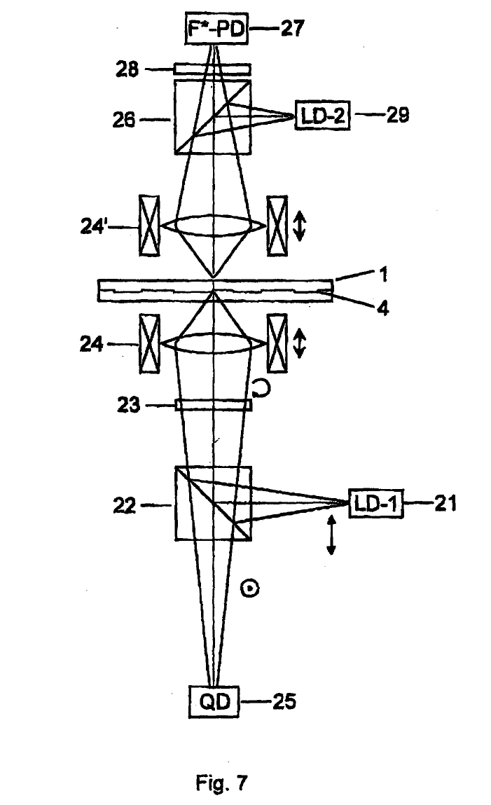

FIG. 7 shows an embodiment for a device according to the invention having separate optics for fluorescence excitation and detection;

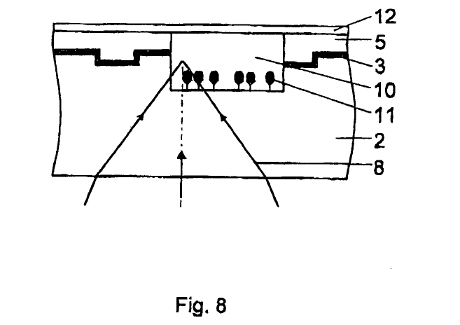

FIG. 8 shows an embodiment of a carrier insertable into a device according to the invention;

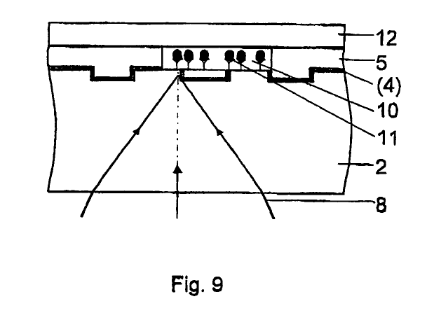

FIG. 9 shows another embodiment of such a carrier;

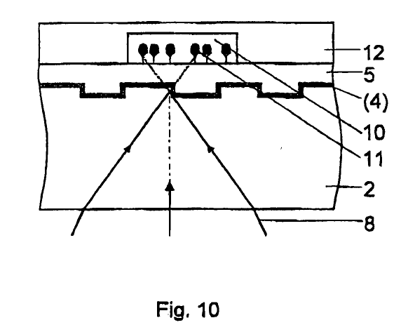

FIG. 10 shows an embodiment of a carrier;

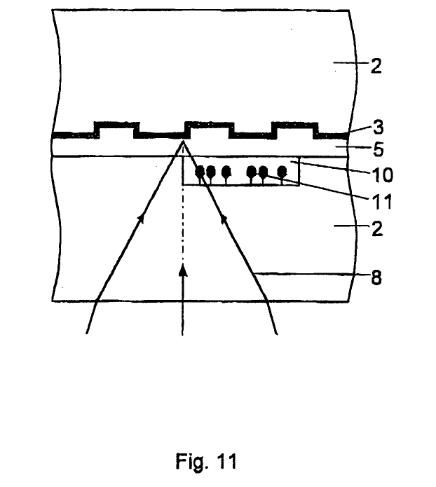

FIG. 11 shows an embodiment of an assembled carrier;

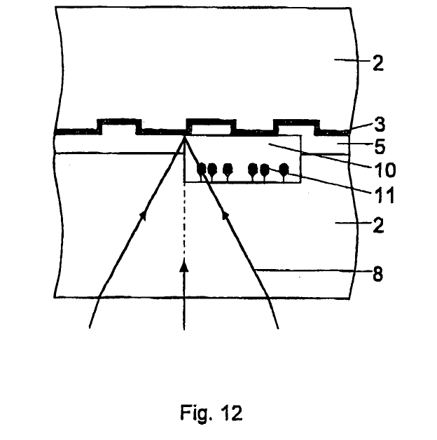

FIG. 12 shows another embodiment of an assembled carrier;

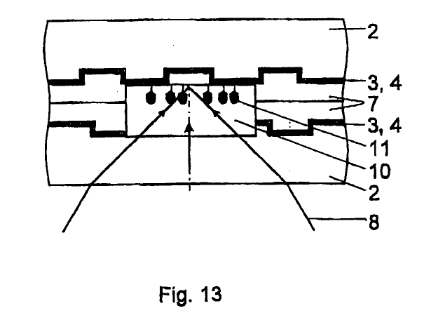

FIG. 13 shows an embodiment of an assembled carrier with information structures arranged in two planes;

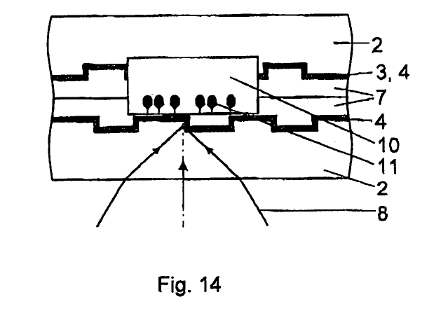

FIG. 14 shows another embodiment of an assembled carrier with information structures arranged in two planes;

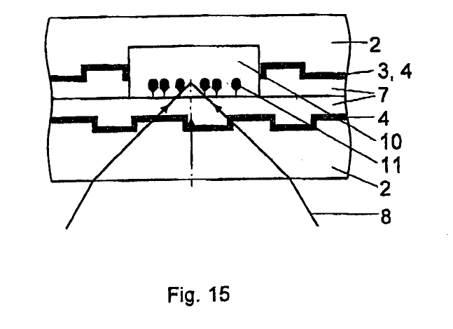

FIG. 15 shows another embodiment of a carrier with two information structures arranged in different planes;

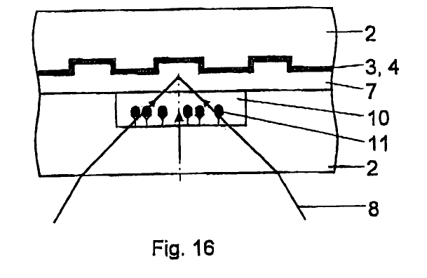

FIG. 16 shows an embodiment of an assembled carrier with one information structure in one plane;

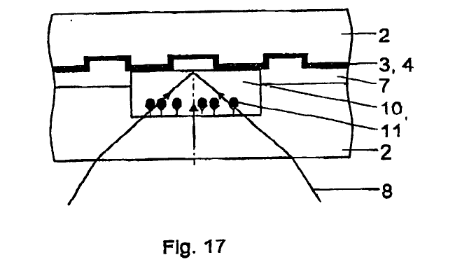

FIG. 17 shows another embodiment of an assembled carrier with one information structure arranged in one plane;

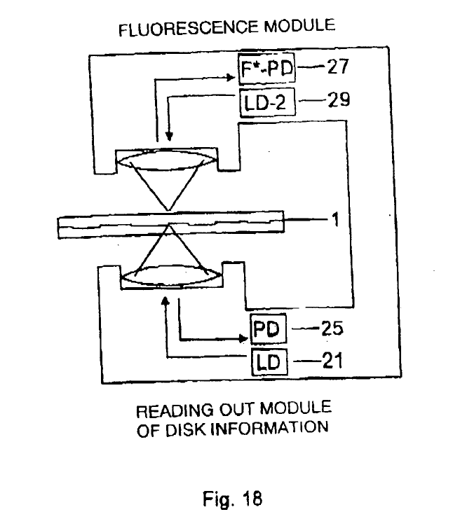

FIG. 18 shows an assembly in a highly simplified form as can be used according to FIG. 7; and

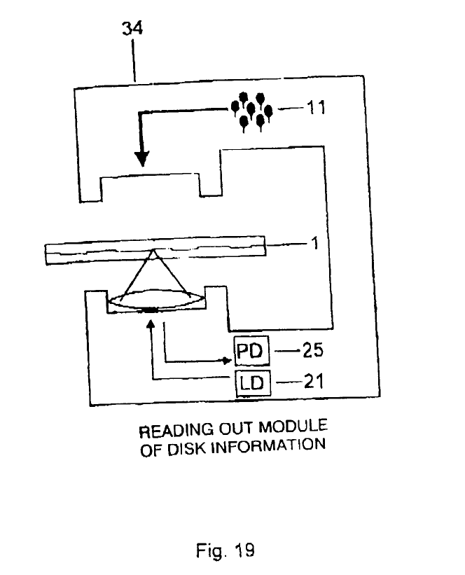

FIG. 19 shows the fundamental assembly of a device according to the invention with an supplemental dispensing means.

With devices as shown in the FIGS. 1 to 7, laser diodes 21 or other light sources 29 can be used with the light thereof having wavelengths by means of which fluorescence of per se well-known fluorophores can be excited. Preferred wavelengths are 635 nm, 650 nm and 780 nm, e.g. wherein laser diodes 21 are already available for this.

As shown in the FIGS. 1 to 6, an optical arrangement A can be inserted into a device according to the invention whereby linearly polarized light of a laser diode 21 can be focussed upon and also into a plate-shaped carrier 1, respectively.

On that occasion, the light of the laser diode 21 will be reciprocated laterally and radially with respect to the rotation axis of the carrier 1 (not shown) together with the optical arrangement A of course, such that the whole carrier surface can be scanned in connection with the rotation of the carrier 1.

The linearly polarized light of the laser diode 21 will be directed through a polarization beam splitter 22 which is a double prism in the embodiment shown here, wherein the one base of a prism can be additionally provided with a λ-long-pass-type coating. Wherein the λ-long-pass-type coating can be required under consideration of the wavelength of the laser diode 21 and/or of light sources 29 and the arrangement of the polarization beam splitter 22, respectively in the optical arrangement.

In the following, with this embodiment a beam splitter 26 separating in a wavelength-selective and spatial manner is arranged with the function thereof will still be dealt below. Subsequently with this, a quarter-wave plate 23 is arranged by means of which the linearly polarized light is converted into circularly polarized light. Subsequent to the quarter-wave plate 23 a focussing optical element 24 is arranged by means of which the light can be focussed upon the surface of the carrier 1 or inside the carrier 1. Advantageously, the position of this focussing element 24 can be changed as it is intimated with the double arrow drawn in the vertical direction, such that the position of focus can be changed. As a result, it is possible for the light to be focussed as required upon a plane in which one information structure 3, 4 or one fluorophore-marked sample is arranged.

The light reflected from the information structure 3, 4 by means of so-called “pits or lands” formed there is a carrier of binary information which can be digitally detected and processed in an electronic evaluation and control unit.

The light reflected from the information structure 3, 4 passes again via the focussing optical element 24 then toward the quarter-wave plate 23 where it is linearly polarized again. On that occasion, the polarization plane of the reflected light is rotated by 90 degrees in comparison with the linearly polarized light emitted from the laser diode 21. By changing the polarization plane it is possible to separate the reflected light via the polarization beam splitter 22, and as can be clearly seen from FIG. 1, to direct upon the optical detector 25 which is preferably a quadrant-shaped diode.

When fluorescence is excited with the light of the laser diode 21 in a premarked sample, the emitted fluorescent light passes through the focussing optical element 21, the quarter-wave plate 23 then toward the spectral filter 26 by means of which a spatial separation of the fluorescent light shall be achieved as well. Also, the spectral filter 26 herein is shown as a double prism, and for this a diochric beam splitter is to be preferably used to separate the fluorescent light and direct upon the optical detector 27 for the fluorescent light. The fluorescent light remains not influenced from the quarter-wave plate 23 since it is not polarized.

For suppressing additional influences of extraneous light, a supplemental filter 28 is arranged in front of the optical detector 27 for the fluorescent light such that the signal-to-noise ratio can be improved.

The embodiment of a device according to the invention shown in FIG. 2 differs from the embodiment according to FIG. 1 merely in the additional use of a collimator 32 and supplemental condensers 33 wherein the latter are focussing the light upon the optical detectors 25 and 27.

With the embodiment shown in FIG. 3 merely the polarization beam splitter 22 und the spectral filter 26, and accordingly the optical detectors 25 and 27 as well are exchanged with respect to the laser diode 21.

With the embodiment according to FIG. 4 it shall be illustrated that the optical guidance of the light of the laser diode 21 can be provided in another modification. Then, first the light of the laser diode 21 is radiated in parallel with respect to the surface of the carrier 1, and folded by 90 degrees towards the carrier 1 by means of the spectral filter 26. The spectral filter 26 is then provided with an unpolarized λ-long-pass type coating.

With such an arrangement of the optical elements the space being provided interior of an apparatus can be better used as the case may be.

In FIG. 5 is shown an embodiment of a device according to the invention in which a supplemental light source 29 is present which can likewise be an appropriate laser diode as already mentioned in the general part of the description. However, the light source 29 should emit light having wavelengths which differ from the light of the laser diode 21.

At least the light of the laser diode 21 or the light source 29 should be able to excite fluorescence of a fluorophore, however, wherein advantageously the two light sources 21 and 29 are allowed to separately excite fluorescence of one fluorophore each.

When light is used which has two wavelengths exciting fluorescence, a second optical detector 27′ for the fluorescent light and a supplemental element separating light having different wavelengths of fluorescence spatially from each other, which are also not illustrated herein, should be used.

For this, a possible solution can be taken from FIG. 6. With this embodiment, there is an optical fibre 31 with the supplemental spectral filter 26′ and the two optical detectors 27 and 27′.

But with the embodiment as shown exactly in FIG. 6, a second light source 29 has been relinquished. However, in order to detect fluorescent light having different wavelengths nevertheless, different fluorophores are allowed to be used which can be excited with approximately the same wavelength and are emitting with different wavelengths, however. The fluorescent light is coupled into the optical fibre 31 via the condensor 33 and coupled out by means of the collector 32, and is directed upon the wavelength-specifically and spatially separating spectral splitter 26′ by means of which the fluorescent light of different wavelength is allowed to be directed in a separated form upon the two optical detectors 27 and 27′.

With the embodiment shown in FIG. 7 the binary, optically detectable information of an information structure 4 which is provided inside the carrier 1, will be detected by means of a laser diode 21, one polarization beam splitter 22, the quarter-wave plate 23 and the focussing optical element 24 and the optical detector 25, and can be used with the already mentioned evaluation and control electronics for controlling the movement (tracking), and on the other hand, for the local allocation of fluorescence signals originating from the fluorophore-marked samples.

On the opposite side of the carrier 1 a second optics are provided which are exclusively used for a fluorescence analysis. With this device, again a light source 29 the light of which is allowed to excite fluorescence of a fluorophore, will be directed upon a spectral filter which is formed herein as a dichroic beam splitter 30, and will be directed therefrom via another focussing optical element 24′ upon fluorophore-marked samples which herein are arranged inside a surface structure formed on the carrier 1. The emitted fluorescent light passes via the focussing optical element 24′ through the dichroic beam splitter 30, one optical filter 28 upon the optical detector 27 for the fluorescent light. The two optical portions arranged above and beneath the carrier 1 are allowed to be mechanically connected rigidly to each other as this is diagramatically intimated in FIG. 18, and accordingly can be moved synchronously.

However, if a laser diode 21 appropriate for the fluorescence excitation and a carrier 1 being at least partially translucent are used, with the embodiment shown in FIG. 7 it is allowed to be done without the additional light source 29 and the dichroic beam splitter 30 as the case may be. With this, for example, in areas in which fluorophore-marked samples are arranged, the information structure 4 can be disconnected such that the light can pass up toward the sample.

But it is also possible to form the information structure 4 such that it is at least partially translucent, and merely a particular portion will be reflected from the information structure 4 which is sufficient to detect the required information signals with the optical detector 25, however, and wherein the light portion passing through the information structure 4 is sufficient for exciting fluorescence.

Different embodiments for the structure of carriers 1 and arrangements of information structures 3, 4 and cavities 10 for holding fluorophore-marked samples are shown in the FIGS. 8 to 17.

The embodiment of a carrier 1 shown in FIG. 8 is substantially formed by means of a per se translucent substrate 2, for example polycarbonate which is typically used for CD and DVD, respectively. On the surface of this substrate 2 a high reflectance coating is formed in the form of an information structure 3 which is disconnected by a cavity 10 for holding fluorophore-marked samples. In the cavity 10 a plurality of bio-molecules 11 is illustrated as an example. Above the high reflectance coating 3 forming the information structure a protective layer 5 is formed which can be optically made of any material.

On the above lying top surface of the carrier 1, a covering coating or a cover 12 is arranged herein by means of which the cavities 10 can be locked. The covering coating or the cover 12 can be optically translucent wherein this must be the case when the fluorescent light is to be detected from the top surface.

In FIG. 8 and in the subsequent Figures the focussed laser light 8 has also been drawn in.

The embodiment of a carrier 1 shown in FIG. 9 differs from the embodiment according to FIG. 8 merely in the arrangement of the cavity (cavities) 10 and the information structure 4 formed as a partially reflecting coating. On that occasion, the cavity 10 is arranged above the information structure 4, and the partially reflecting coating 4 ensures that a portion sufficient for the fluorescence excitation is transmitting into the sample, and simultaneously it is allowed for a sufficient light portion to be reflected on the coating 4 such that information can be gained from this area as well.

These facts of the case also apply analogously to the embodiment of a carrier 1 shown in FIG. 10 in which the cavity 10 is formed herein inside a covering coating or a cover 12.

The embodiment of a carrier 1 shown in FIG. 11 which can be used according to the invention is allowed to be assembled from two substrates 2 which are bonded to each other. Then, in the substrate 2 illustrated herein below the cavities 10 for holding the fluorophore-marked samples with the bio-molecules 11, and the information structure herein as a high reflectance coating 3 are provided in the substrate 2 arranged thereabove. Both substrates 2 are allowed to be bonded to each other with a suitable polymer such as a polymeric protective layer 5.

FIG. 12 differs from the embodiment according to FIG. 11 merely in that the cavities 10 reach up to the information structure 3 which reduces the requirement with respect to the setting capacity of the focal position of the laser beam 8, and the information from the information structure 3 as well as the fluorescence signals can be detected very accurately in a spatially resolved manner without changing the focal length of the focussing optical element 24.

With the embodiment of a carrier 1 shown in FIG. 13 again two substrates are used in a form connected to each other wherein the cavities 10 are formed between the two substrates 2. An information structure 3, 4 each is formed in the two substrates. On that occasion, either it may concern with a partially reflecting coating 4 or a high reflectance coating 3.

Then, in the illustrated form when the focussed laser light 8 is focussed from below into the carrier 1, the information structure in the substrate 2 arranged below has been formed partially reflecting such that a certain portion of light is also allowed to pass toward the information structure 3 formed in the upper substrate 2 which should be high reflecting then, and light correspondingly reflected therefrom is allowed to be detected by the optical detector 25 such that the number of information per area can be increased.

With the carriers 1 shown in the FIGS. 13 to 17 the two substrates 2 each are connected with a bonding agent coating 7.

The embodiment according to FIG. 14 differs from the embodiment according to FIG. 13 by a mirror-symmetrical arrangement of the two substrates 2, and the embodiment according to FIG. 15 in that the cavities 10 are exclusively provided inside the substrate 2 arranged thereabove.

The embodiments according to the FIGS. 16 and 17 merely use a single information structure 3, 4 again which is formed inside the substrate 2 provided above, and only the arrangement of the cavities 10 with the embodiments shown in the FIGS. 16 and 17 is differing.

In the embodiments for the carrier 1 as shown in the FIGS. 13 to 17 any breakes do not appear during the detection of information signals which can be gained by means of the information structures 3, 4 if fluorescence signals are simultaneously detected by corresponding fluorescence excitation of fluorophores.

With the FIG. 19 it shall be diagrammatically intimated a possibility which allows a high grade automatization of the sample preparation and sample evaluation.

With this, beneath the carrier 1 embodiments of a device according to the invention as they are shown in the FIGS. 1 to 6 can be used. A dispensing means for the samples is provided above the carrier 1 which is allowed to be controlled by means of the gained information signals such that feeding the samples can take place with a high precision with respect to the respective position and the volume.

During the biochemical preparation of the carriers and samples it is allowed to fall back on knowledges per se well-known such that the most different biochemical interactions can be achieved and detected with the solution according to the invention.

1. A device for carrying out biochemical fluorescence tests wherein linearly polarized light of a laser diode (21) is directed upon a plate-shaped carrier (1) by means of an arrangement (A) comprising at least one polarization beam splitter (22), a quarter-wave plate (23) and a focussing optical element (24),
the carrier (1) rotating about an axis is provided with binary, optically detectable information structures (3, 4), and a plurality of fluorophore-marked samples is arranged in a discrete manner on the surface of and/or inside said carrier (1);
light reflected from the information structures (3, 4) is directed upon an optical detector (25) by the optical arrangement (A) for detecting the information, and
fluorescent light emitted from fluorophore-marked samples is directed upon an optical detector (27) for the fluorescent light via a wavelength-selectively and spatially separating spectral filter (26).

2. A device according to claim 1,
characterized in that said spectral filter (26) is a dichroic beam splitter provided with a λ-short-pass type coating.

3. A device according to claims 1 or 2,
characterized in that said spectral filter (26) or said polarization beam splitter (22) are provided with a λ-long-pass type coating.

4. A device according to any one of claims 1 to 3,
characterized in that an optical filter (28) is provided between said spectral filter (26) and said optical detector (27) for the fluorescent light.

5. A device according to any one of claims 1 to 4,
characterized in that said spectral filter (26) and said optical detector (27) for the fluorescent light are arranged on the side of said carrier (1) opposite said optical arrangement (A).

6. A device according to any one of claims 1 to 5,
characterized in that said spectral filter (26) is integral part of said optical arrangement (A).

7. A device according to any one of claims 1 to 6,
characterized in that a second light source (29) is available for fluorescence excitation;
that light of said light source (29) is directed upon said carrier (1) by means of a second dichroic beam splitter (30), wherein the light rays of said laser diode (21) and said light source (29) are interfering with each other.

8. A device according to any one of claims 1 to 7,
characterized in that the focal length of said focussing element (24) is variable.

9. A device according to any one of claims 1 to 8,
characterized in that the detection of optical information signals and of said fluorescent light from said laser diode (21) and/or said light source (29) takes place in a confocal manner.

10. A device according to any one of claims 1 to 9,
characterized in that said fluorescent light is directed at least upon one optical detector (27, 27′) via an optical fibre (31).

11. A device according to claim 10,
characterized in that said fluorescent light emitting from said optical fibre (31) is directed upon an optical detector (27 or 27′) each via one spectral filter (26′) separating in a wavelength-selective and spatial manner.

12. A device according to any one of claims 1 to 11,
characterized in that at least said laser diode (21) comprising said optical arrangement (A) and said spectral filter (26) is laterally movable in the radial direction with respect to the rotation axis of said carrier (1), and the movement is controllable by means of an electronic evaluation and control unit depending on the information detected from said carrier (1) with said optical detector (25), and said fluorescence signals are detectable in a spatially resolved manner.

13. A device according to any one of claims 1 to 12,
characterized in that the focal length of said focussing optical element (24) is adjustable for the excitation and detection of fluorescence of said fluorophore-marked samples with said electronic evaluation and control unit depending on the information detected by said carrier (1).

14. A device according to any one of claims 1 to 13
characterized in that the individual samples are deposited upon said carrier (1) or inserted into cavities (10) or channels formed in said carrier (1) by means of a dispensing unit (34) connected to said electronic evaluation and control unit.

15. A device according to any one of claims 1 to 14,
characterized in that said carrier (1) is a CD or DVD modified for receiving samples.

16. A method for carrying out biochemical fluorescence tests with a device according to any one of claims 1 to 15, wherein a spatially resolved and/or an immediate allocation of detected fluorescent light of one fluorophore-marked sample each is carried out by means of said signals detected from said information structures (3, 4) formed on and in said carrier (1), respectively.

17. A method according to claim 16,
characterized in that prior to carrying out fluorescence tests said optically detectable information structures (3, 4) of said carrier (1) are used to control a dispensing unit (34) for discrete feeding samples on and in said carrier (1), respectively.

18. A method according to claims 16 or 17,
characterized in that said fluorescence tests of said individual fluorophore-marked samples are carried out under consideration of the locus coordinates detectable from said information structures (3, 4) and/or of information allocated to one fluorophore-marked sample.

19. A method according to any one of claims 16 to 18,
characterized in that the focal length of said focussing optical element (24) is adjusted with said electronic evaluation and control unit such that light for the excitation of fluorescence of said laser diode (21) and/or said light source (29) is focussed upon a fluorophore-marked sample.

20. A method according to any one of claims 16 to 19,
characterized in that fluorescent light emitted from said fluorophore-marked samples is separated from fluorescence exciting light by means of a spectral filter (26) separating in a wavelength-selective and spatial manner, and is directed upon an optical detector (27) for said fluorescent light.
